(19) United States
(12) Patent Application Publication
(10) Pub. No.: US 2023/0123130 A1
(43) Pub. Date: Apr. 20, 2023

(54) GLASS PANES OR LAMINATES HAVING A COATING ON AT LEAST ONE SIDE AND PASTES FOR PRODUCING SUCH A COATING

(71) Applicants: SCHOTT AG, Mainz (DE); SCHOTT Technical Glass Solutions GmbH, Jena (DE)

(72) Inventors: Yvonne Menke-Berg, Wiesbaden (DE); Ricarda Krechel, Sprendlingen (DE); Hubert Wieseke, Jena (DE)

(73) Assignees: SCHOTT AG, Mainz (DE); SCHOTT Technical Glass Solutions GmbH, Jena (DE)

(21) Appl. No.: 18/046,877

(22) Filed: Oct. 14, 2022

(30) Foreign Application Priority Data
Oct. 14, 2021 (DE) 10 2021 126 693.9
May 12, 2022 (DE) 10 2022 111 945.9

(51) Int. Cl. C03C 3/089; C03C 8/02; C03C 17/04

(52) U.S. Cl. CPC C03C 3/089; C03C 8/02; C03C 17/04; C03C 2217/214; C03C 2217/213; C03C 2217/228

(57) ABSTRACT

Coated glass panes having a glass pane and a coating in at least one region of at least one side of the glass pane. The glass pane is composed of glass with SiO₂ and B₂O₃. The coating includes first coating applied in at least one region of the at least one side. The first coating has a binder with SiO₂ and a pigment. The glass pane, in the at least one region, has a flexural strength between at least 5 and at most 170 MPa.

### CROSS REFERENCE TO RELATED APPLICATIONS

This application claims benefit under 35 USC § 119 of German Application 10 2021 126 693.9 filed Oct. 14, 2021 and claims benefit under 35 USC § 119 of German Application 10 2022 111 945.9 filed May 12, 2022, the entire contents of all of which are incorporated herein by reference.

### BACKGROUND

### 1. Field of the Invention

The present invention relates generally to glass panes, in particular to glass panes having a coating in at least one region of at least one side of the glass pane. The invention relates specifically to glass panes comprising a glass comprising SiO₂ and B₂O₃ and in particular to glass panes composed of or comprising a borosilicate glass. In a further aspect the invention further relates to a paste for producing a coating of such a glass pane, to a laminate comprising such a glass pane and to the use thereof.

### 2. Description of Related Art

Glass panes composed of or comprising borosilicate glasses, in particular also those which are at least partially coated, have long been known and are used for example as oven sightglasses in oven doors. The advantages of borosilicate glass are the thermal resistance thereof compared to conventional soda lime glasses, pyrolysis furnaces for example thus often comprising such borosilicate glass panes.

However, borosilicate glasses may be advantageous for other applications too since such glasses have inherent advantages for example in terms of scratch resistance/general mechanical resistance and also chemical resistance relative to the known soda lime glasses. Such borosilicate glass panes are thus increasingly also employed in windshields.

It is known to employ borosilicate glass, as commercially available under the trade name Borofloat® for example, in the exterior glazing of vehicles. Such a glass is for example very well suited for laminated glazing and features a very high transmission in the range of visible light. Furthermore such borosilicate glasses exhibit very good thermal resistance, high chemical resistance and good mechanical strength.

For example international patent application WO 2015/059406 A describes laminated glass panes. One of the panes, for example the outer layer, may comprise a borosilicate glass for example.

International patent application WO 2017/157660 A1 describes a laminated glass pane for a head-up display. Here too, one of the panes of the laminated glass may comprise borosilicate glass.

CO 2017/0005596 A1 likewise describes an auto glass pane with high resistance.

International patent application WO 2019/130285 A1 describes a laminate with high resistance to abrasion and environmental influences.

Finally, international patent application WO 2018/122769 A1 describes a laminate with high breaking strength.

For the safety of the vehicle occupants, windshields are configured as laminated glass panes and typically have a coating in the edge region. This coating serves both for optical lamination of for example bonded constituents or components such as antennas for example and for protection thereof from UV radiation. This border is preferably arranged between the two glass panes of a laminate. The laminate further also comprises a polymeric ply, i.e., a ply comprising or consisting of a polymer, between the two glass panes which bonds the glass panes together. The glass panes having the coating arranged therebetween in at least one region, in particular in the edge region, are placed on top of one another and bent in a thermal forming process. A polymeric ply is subsequent introduced between the two panes and the bent glass panes are bonded together to finally afford a laminated glass pane (in the context of the present disclosure also referred to simply as a “laminate”).

Glass panes comprised in such a laminate must therefore meet a series of requirements. Since the bending processes are thermal, the glass panes and the coating applied thereto must be able to withstand these temperatures. The glass panes and the coating must be able to form a bond of such a kind that a stable laminate is formed and that delamination between the glass and the polymer does not occur. This is because it is necessary for the coating to have an optical density sufficient to ensure that components arranged in the border region of the windshield are not disruptively visible. This prevents the driver being distracted and thus increases driving safety. Microcracks or other defects in the coating are also to be avoided or at least minimized wherever possible.

Also important, as well as the temperature resistance of the glass and the coating, the abovementioned compatibility of the glass/the coating with a polymeric material to form a laminate, the optical density and the minimization of possible defects, is the mechanical strength, for example characterized by the breaking strength, of a coated glass pane. It is known that coatings, and especially coatings having particularly good adhesion, can impair the strength of a glass pane. Especially coatings having particularly good adhesion, such as glass based coatings, can critically reduce mechanical strength, such as breaking strength or flexural strength. This applies in principle to all glass substrates but especially so when the substrate, i.e., the glass pane, has a low coefficient of expansion, such as is the case in borosilicate glass panes. This is because the use of known ceramic paints for example can result in differences in the coefficients of expansion of the coating and the substrate which are considered causative for the observed losses in strength of coated glass panes.

There is therefore a need for coated glass panes which at least ameliorate the abovementioned weaknesses of the prior art.

### SUMMARY

It is an object of the present invention to provide an at least partially coated glass pane for a vehicle which at least partially ameliorates the weaknesses of the prior art. Further aspects of the invention are directed to a paste, in particular for producing a coating of such a glass pane, and to a laminate which comprises such a glass pane and to the use thereof.

The invention therefore relates to a glass pane for a vehicle comprising a glass comprising SiO₂ and B₂O₃. The glass pane comprises at least one coating comprising a first coating applied in at least one region of at least one side of the glass pane. The first coating comprises at least one binder comprising SiO₂, at least one pigment and preferably at least one addition. In the at least one region which comprises the applied first coating on the at least one side of the glass pane the glass pane has a flexural strength between at least 5 and at most 170 Mpa, for example between 5 Mpa and at most 80 MPa. Preferred ranges are between at least 20 and at most 170 Mpa, preferably at least 35 Mpa, particularly preferably at least 60 Mpa and most preferably at least 80 MPa. In one embodiment the binder may be glass-based, in particular in the form of glass frit, and the coating may be in the form of an enamel layer. In one embodiment the addition may be present and in the form of a filler.

A glass pane for a vehicle is generally to be understood as meaning a glass pane for mobile applications, i.e., for example for airplanes and/or automobiles.

Such a glass pane has a series of advantages.

In the present case the glass pane comprises a glass comprising SiO₂ and B₂O₃, i.e., a so-called borosilicate glass. This type of glass material (or glass for short) is a chemically very resistant which is also mechanically resistant and, compared to conventional glasses such as soda lime glasses, has a good thermal stability and good mechanical strength even in a non-pre-stressed state. It has also been found that the scratch resistant of such borosilicate glasses is higher than that of soda lime glasses.

The coating is arranged in at least one region on at least one side of the glass pane. The coating is preferably arranged in the form of a border over the entire edge region of one side of the glass pane, wherein it is further possible that towards the middle region of the glass pane the coating is no longer opaque but rather applied in the form of a so-called dot matrix. This may be advantageous when the glass pane is used as a constituent of a laminate employed as a windshield.

For example it may be advantageous when for the thicknesses of the coating specified in more detail hereinbelow the coating has an optical density of at least 1 and at most 4.5, for example at most 3, preferably more than 2. The optical density is determined in a region in which the coating is applied all over.

In the present case the coating is in the form of a chemically and thermally resistant coating. This is to be understood as meaning that the coating comprises a binder comprising SiO₂. SiO₂ exhibits good chemical resistance and is also heat stable.

The coating further comprises at least one pigment. In the context of the present disclosure the pigment is to be understood as being a particle-based colorant. According to the present disclosure the pigment is advantageously also heat stable and is preferably a ceramic colorant. In the context of the present disclosure reference to a colorant (or pigment) is to be understood as meaning that the colorant consists of particles which may presently also be referred to as pigment particles. If in the context of the present disclosure it is stated that the coating comprises a pigment this is to be understood as meaning that the coating comprises particles of a particular pigment or colorant, i.e., particles having the composition of the pigment or colorant.

Ceramic colorants or ceramic pigments per se are known to those skilled in the art. For example these may be metallic mixed oxides such as spinels, hematites or pure oxides such as TiO₂.

In one embodiment the first coating may further comprise an addition. However, this is not generally necessary and it may also be preferably for the first coating not to comprise an addition.

In one embodiment the binder is glass-based and in the form of a glass frit and the coating is an enamel layer. In this preferred embodiment the coating further comprises an addition in the form of a filler. In this preferred embodiment it may also be provided that the coating additionally comprises one or more further additions though this is not mandatory.

The inventors have found that such an embodiment makes it possible to achieve a particularly good strength of the coated glass pane. It is thought that this is because a particularly good layer construction in which a certain porosity in the coating may be achieved through uniform distribution of fillers in the coating is achievable in this way. In particular, as is also shown in the figures, it appears that such a configuration of glass panes can also result in a porosity of the coating which is especially directed towards the coating/glass pane interface and thus in the region of the so-called melting-reaction zone.

In a preferred variant of this embodiment the glass pane is therefore configured such that it has a porosity gradient, wherein the porosity of the coating decreases from the glass pane towards the surface of the coating.

If in the context of the present application reference is made to a glass pane this is a coated glass pane unless expressly stated otherwise.

Especially in the region in which the coating disclosed above has been applied the coated glass pane according to embodiments generally has a flexural strength between at least 5 MPa and at most 170 MPa, for example between 5 MPa and at most 80 MPa. Preferred ranges are between at least 20 and at most 170 Mpa, preferably at least 35 Mpa, particularly preferably at least 60 Mpa and most preferably at least 80 MPa. This ensures sufficient strength of the coated glass pane for use as a pane in a laminate for example. The flexural strength of the (coated) glass pane in the coated region is preferably at least 50% of the flexural strength of the uncoated glass pane. The flexural strength of an uncoated glass pane of identical composition and configuration is preferably between at least 100 MPa and at most 210 MPa, for example at most 200 MPa, for example about 150 MPa. Mechanical strength, for example flexural strength, is a statistical value and it therefore goes without saying that it is not the same pane that was analyzed for flexural strength before and after coating; on the contrary the above indications relate to analyses performed on uncoated glass panes and coated glass panes of identical compositions and configuration. In the context of the present disclosure flexural strength is to be understood as meaning the strength of the glass pane also referred to as the double ring bending strength which was in each case determined according to DIN 1288-5. In the context of the present disclosure the reported strength value is in each case the arithmetic mean.

In one embodiment the areal coverage rate of the at least one side of the glass pane with the coating is at least 10% and at most 80%, preferably at least 15% and at most 65%, of the total surface area on the side of the pane on which the coating has been applied.

In the context of the present disclosure a pane is generally to be understood as meaning a pane-shaped shaped article. A glass pane (which may be coated or uncoated) is a pane comprising/composed of glass. A shaped article is pane-shaped when its spatial dimensions in a spatial direction of a Cartesian coordinate system is at least one order of magnitude smaller than the spatial dimensions in both further spatial directions of the Cartesian coordinate system perpendicular to the first special direction. In other words the thickness of the shaped article is at least one order of magnitude smaller than its length and width. The two main surfaces of the pane, i.e., those whose size are determined by length and width, are in the context of the present disclosure also referred to merely as sides for short.

In a further embodiment the visual transmission, τᵥᵢₛ, in the at least one region of the glass pane in which the coating is arranged is at most 10%, preferably at most 7% and particularly preferably at most 5%, very particularly preferably at most 1%. In one embodiment τᵥᵢₛ is at least 0.01%, preferably at least 0.05% and preferably at most 0.3%. These values relate to a region in which the coating covers the glass pane all over.

The coating may be applied to the glass pane in the at least one region opaquely—i.e., “all over”, that is to say without interruption in the coating, based on the region—but may also be arranged for example in the form of a so-called dot matrix. Combinations of these variants are also possible. It is also possible for example for an all-over coating, i.e., one without interruptions in the coating, arranged on the glass pane in the edge region of the coating to transition into a dot matrix typically towards the centre of the glass pane. This is for example a customary configuration of the coating, which in this case is thus arranged on the glass pane in structured form, for glass panes employed in vehicle windshields.

In a further embodiment the binder is glass-based. It may preferably be provided that the coating is in the form of an enamel layer.

In the presently preferred embodiments the coating has a thickness between 3 μm and 30 μm, preferably between 4 μm and 15 μm, particularly preferably less than or equal to 13 μm.

In one embodiment the first coating comprises an addition in the form of a filler if the binder is glass-based in the form of a glass frit and the resulting coating is in the form of an enamel layer. In this specific embodiment the filler comprised by the first coating is preferably a filler having a linear coefficient of thermal expansion between −10*10⁻⁶/K and +10*10⁻⁶/K. It is preferable when the linear coefficient of thermal expansion is between −8*10⁻⁶/K and +5*10⁻⁶/K, particularly preferably between −6.5*10⁻⁶/K and +3*10⁻⁶/K.

In yet a further embodiment in the at least one region in which the coating is arranged the glass pane has an optical density for the abovementioned thicknesses of the coating of at least 1 and at most 4.5, for example at most 3. The optical density or color density is used to characterize the absorption behavior of a coating compared to an “absolute white”. The denser the color layer, the less light can pass through it. The optical density is calculated by the following formula:

$$D = log ( \frac{1}{R} )$$

R is the degree of remission. Optical density is determined with the densitometers, especially in the context of the present disclosure in the vertical direction to the greatest areal extent of the coating and thus of the coated surface of the coated glass pane. The higher the optical density, the less transparent the coating appears.

A glass-based coating is generally to be understood as meaning a coating which comprises predominantly, i.e., to an extent of more than 50% by weight, inorganic, amorphous binder. In particular, such a glass-based coating may also comprise a binder which is substantially, i.e., to an extent of at least 95% by weight, or even completely inorganic and amorphous. In addition to the binder a glass-based coating may generally also contain further constituents. According to the present disclosure the coating still comprises at least one pigment.

A glass-based coating may in particular also be understood as meaning a coating comprising a sol-gel-based binder.

However, glass-based coatings especially also comprise so-called enamel coatings.

In the context of the present disclosure enamel coatings or enameled layers are to be understood as meaning coatings comprising a glass frit or glass flux as binder. During baking of such coatings the constituents of the glass flux, and thus of the glass frit, melt and a melting reaction zone can form at the surface of the substrate, for example of the glass pane. In the context of the present disclosure the terms frit, glass frit and glass flux are each used synonymously with one another. The molten glass further flows and encapsulates any further constituents comprised by the enamel paint/the coatings resulting from such a paint, for example pigment particles and/or filler particles. Enamel layers are therefore particularly preferred in one embodiment. This is because particularly mechanically stable coatings are obtainable in this way. The surface of such a layer is also glassy and, depending on the precise composition of the glass frit, may in some cases even be quite similar to the composition of the glass of the glass pane. It is thus advantageously also possible in one embodiment for the strength of the bond between the two glass panes of a laminate in different regions not to differ greatly in different regions but rather for the bond to be uniform over the whole side of the glass pane.

In the context of the present disclosure a glass flux or (synonymously) a glass frit is to be understood as meaning a glass-based binder which is suitable for forming a glaze and/or enamel layer. This may in particular be a glass powder which is suitable and determined for application to a substrate using a printing process, wherein the glass powder may also be admixed with any further constituents, for example pigments. Such glass fluxes/glass frits preferably have a lower melting point and/or softening point than the corresponding substrate material, in particular than the material of a glass pane to be coated.

In a further embodiment a further coating, in particular in the form of an intermediate layer, is arranged between the glass pane and the first coating in at least one subregion of the region of the at least one side of the glass pane in which the first coating is applied. In this further embodiment the entire presently disclosed coating thus comprises the first coating and the further coating. For brevity the entire coating is also in some cases hereinbelow referred to merely as the coating for simplicity.

Such a further coating which is arranged as an intermediate layer between the glass pane and the coating can be very advantageous, in particular for embodiments of the glass pane where the difference in the linear coefficients of thermal expansion between the coating and the glass pane is of a magnitude such that a critical reduction in the strength of the coated glass pane results. This is because in this case the further coating arranged between the first, pigmented coating and the glass pane can act as a type of compensating layer. A similar type of coating is described for example in European patent specification EP 3 022 164 B1.

Such a further coating or intermediate layer can be advantageous precisely for cases in which the first, pigmented coating is in the form of an enamel layer. This is because, as described above, in the case of such enamel coatings the melting of the glass flux/the glass frit often results in a so-called melt reaction zone at the contact between the surface of the substrate, i.e., the glass pane in this case, and the coating. While this intimate bond on the one hand results in a great adhesive strength of the coating it can also lead to the formation of cracks in the case of great differences in the linear coefficient of thermal expansion. In contrast to glass-based coatings comprising no enamel but rather a sol-gel binder for example, an enamel coating, also referred to as a frit coating in the context of the present disclosure, forms a reaction zone. In the coating of a glass substrate, such as a glass pane, this reaction zone is very fine and visible in an SEM only with difficulty, if at all. Cracks are not necessarily formed but it may be the case that the reaction zone exhibits different mechanical properties to the glass pane and the first coating. Provided only one such reaction zone is formed, the specific formation thereof with different properties to the substrate (here the glass pane) and the first coating can also have the result that the strength of the coated pane is reduced. In the case of crack formation said cracks are not only disruptively visible but can also sensitively impair the strength of the coated substrate, i.e., the glass pane in this case. It may especially be possible that depending on the precise configuration of the coating and/or the glass pane a sufficient flexural strength of the coated glass panes between at least 5 and at most 170 MPa, for example between 5 MPa and at most 80 MPa or between at least 20 and at most 170 MPa, preferably at least 35 MPa, particularly preferably at least 60 MPa and most preferably at least 80 MPa, is no longer assured. In this case an intermediate layer as a further coating, for example a layer which is in turn glass-based, in particular a glass flux-based layer, may serve as a type of modulation layer. Such a further coating may in particular be unpigmented. In may be advantageous when the further coating or intermediate layer comprises the same glass flux as the first pigmented coating but is pigment-free. In this case a gradient-like transition between the further coating and the first coating may result. In one embodiment another type of intermediate layer is in the form of a porous layer, for example through a high pigment content, which absorbs the stresses and a sealing layer thereabove composed of frit comprising little, if any, pigment.

The terms “further coating” and “first coating” do not refer to the sequence of application but merely to the fact that the “first coating” is always present but the further coating may be present on a merely optional basis, i.e., according to embodiments.

However, it is generally also possible, without limitation to the above-described embodiment of the further coating as a modulation layer, for the further coating to assume other functions and/or comprise a different glass flux/a different glass frit to the first coating and/or to be in the form of a non-glass based coating or at least not to be in the form of an enamel layer.

The presently disclosed coating may thus comprise the first coating and the further coating as an intermediate layer or merely comprise the first coating depending on the embodiment.

The paste for the first coating may generally comprise between 0.5% by volume and 50% by volume, preferably less than 40% by volume, of pigment, and between 50% by volume and 99.5% by volume of binder, for example glass frit, based on the solids content comprised by the paste.

In a further embodiment the first coating comprises between 0.5% by volume and 50% by volume of pigment, preferably between 0.5% and 40% by volume of pigment, especially preferably between 20% and 40% by volume of pigment.

The content of binder in the first coating is between 99.5% by volume and 40% by volume of binder, preferably between 99.5% and 50% by volume of binder, especially preferably between 80% and 55% by volume of binder, for example between 80% and 60% by volume of binder, preferably glass-based binder, wherein the binder is particularly preferably a glass frit. In a further preferred embodiment the content of binder in the first coating can comprise in general between 78% and 50% by volume.

In one embodiment where the coating comprises not only the binder and the pigment but also an addition, for example an addition in the form of a filler, it may generally be provided that the lower limit of the binder content is at least 50% by volume.

A configuration of the coating and correspondingly the glass pane provided with the coating may be advantageous since this makes it possible to obtain a coating which has sufficient optical density. This is because at the presently disclosed thicknesses of the entire coating the pigment content, in particular of at least 0.5% by volume of pigment, in particular in the first coating, ensures that an optically dense, preferably even an opaque, coating is obtained. Said coating may accordingly be used for laminating components or elements arranged in the border region of a windshield for example. The pigment content may also be higher and may be 10% by volume for example or even more.

However, the pigment content should generally not be excessively high. The pigment content of the coating in the first coating is not more than 50% by volume and is preferably not more than 40% by volume, in particular in the case where an uncolored glass frit is used as binder. This ensures that a sufficient a binder content is present. As mentioned, the binder preferably encapsulates the pigment particles and thus bonds these to one another and to the substrate—presently the glass pane—to afford a coating with good adhesion, especially when the presently described intermediate layer is arranged between the coating and the glass pane.

Provided that the coating, in particular the first coating, comprises only the binder in addition to the pigment/the pigment particles, the volume fractions of binder and pigment preferably sum to 100. In other words, in this embodiment the coating comprises between 99.5% by volume and 50% by volume of binder, preferably glass-based binder, for example glass flux/glass frit. The proportion of one or more additions in the form of fillers may also be added thereto. The volume determines the mechanical and optical properties. When calculating the composition of the coating, in particular of the first coating, the solids composition is used as a basis. If the coating also comprises an addition in addition to at least one pigment it is necessary to make the following distinction: If the addition is a blowing agent this addition is not included in the solids content but additionally calculated, i.e., in the case of a coating with pores the final layer composition is inorganically identical to a dense layer but pores are additionally incorporated. If the addition is a filler, i.e., a solid substance, which does not decompose and is incorporated into the coating this is taken into account when calculating the solids contents in customary fashion.

Advantageously the volume ratio of the pigment to the binder is also maintained in an embodiment where the coating comprises further components, for example a certain proportion of additions, for example fillers or pore-formers.

In yet a further embodiment the glass of the glass panes has a linear coefficient of thermal expansion between 2*10⁻⁶/K and 6*10⁻⁶/K. This is advantageous because this makes it possible to configure the glass pane using known, low-expansion borosilicate glasses which already entail a rather high intrinsic glass strength. Furthermore, such glasses also exhibit quite good thermal resistance and are also quite chemically resistant.

In one embodiment the glass of the glass pane advantageously comprises at least 60% by weight of SiO₂ to at most 85% by weight of SiO₂ and/or at least 7% by weight of B₂O₃ to at most 26% by weight of B₂O₃. Such glasses are in particular advantageous because they provide a good compromise between mechanical, chemical and thermal resistance on the one hand and good meltability on the other hand, without demixing tendencies and/or excessive viscosities of the glass melt having a disruptive effect.

In one embodiment the coating advantageously has a linear coefficient of thermal expansion between at least 3*10⁻⁶/K and at most 10*10⁻⁶/K, preferably of less than 9*10⁻⁶/K, particularly preferably of less than 7.5*10⁻⁶/K, very particularly preferably of less than 6*10⁻⁶/K. This embodiment may in particular be linked or connected to embodiments of the glass pane where the linear coefficient of thermal expansion of the glass of the glass pane is likewise limited and is between 2*10⁻⁶/K and 6*10⁻⁶/K. This is because this makes it possible in particularly simple fashion to obtain glass panes comprising a pigmented coating comprising a glass based binder which exhibit sufficient flexural strength. However, it is generally also possible to combine coatings having linear coefficients of thermal expansion within the abovementioned limits with glass panes exhibiting a markedly higher, divergent linear coefficient of thermal expansion and vice versa. However, other measures for compensating the coefficient of expansion difference will then be undertaken. This may be effected for example via a so-called modulation layer or intermediate layer as a further coating as described above.

In one embodiment of the coating as an enamel layer it may be provided that the linear coefficient of thermal expansion is less than 7.5*10⁻⁶/K, preferably less than 6*10⁻⁶/K. This may in particular be the case when in addition to the thermal expansion of the resulting coating, further properties of the coating are taken into account, for example sufficient scratch resistance.

However, other possibilities are in principle also conceivable.

A configuration in particular of the first coating such that said coating comprises not only the glass-based binder and the pigment but also one or optionally more additions is thus generally also conceivable.

In the context of the present disclosure an addition is generally to be understood as meaning a solid added to a coating composition preferably in particulate form/as a powder.

Such an addition may be a filler for example. In the context of the present disclosure a filler is to be understood as meaning in particular inorganic solids which do not act as colorants in a coating. They are therefore solids which do not themselves act as pigments but are added to the coating for other reasons. For example, such fillers may be used to improve scratch resistance or for crack deflection (platelet- or needle-shaped) or for establishing a low coefficient of expansion α of the composite layer and thus in particular of the coating.

A configuration of the coating such that said coating comprises at least one addition in the form of a filler may presently be advantageous, in particular in the case of large differences in coefficients of thermal expansion of the glass pane (or of the glassy material of the glass pane) and the coating. One embodiment therefore provides that the first coating comprises at least one filler.

It may be particularly advantageous when the filler is configured such that it can at least reduce differences in coefficients of thermal expansion between the employed pigment or pigments, the glass flux/the binder in general and the substrate. It is therefore provided in a specific embodiment that the filler is a filler having a linear coefficient of thermal expansion between −10*10⁻⁶/K and +10*10⁻⁶/K. It is preferable when the linear coefficient of thermal expansion is between −8*10⁻⁶/K and +5*10⁻⁶/K, particularly preferably between −6.5*10⁻⁶/K and +3*10⁻⁶/K.

When in the context of the present application reference is made to the coefficient of thermal expansion this is to be understood as meaning the linear coefficient of thermal expansion. Unless otherwise stated said coefficient is reported in the range of 20-300° C. The terms α and α₂₀₋₃₀₀ are used synonymously in the context of the present invention. Especially for glassy materials said coefficient may be determined in a method according to ISO 7991. The coefficient of thermal expansion of the coating is in each case to be understood as meaning the resulting coefficient of thermal expansion of the particular coating which results from the coefficients of thermal expansion of the individual constituents of the coating, taking into account their proportions in the coating. If in the context of the present invention reference is made to the coefficient of thermal expansion of the glass pane this is always to be understood as meaning the coefficient of thermal expansion of the glassy material (or glass) of the glass pane (i.e., of the substrate).

As explained above an addition, in particular in the form of a low-expansion filler, is an opportunity to specifically adjust, in particular to minimize, the coefficient of thermal expansion and correspondingly the coefficient of thermal expansion difference between the coating and the glass pane. Such a filler may be for example a low-expansion or even negative-expansion filler, for example silica or β-eucryptite or cordierite. However, alternatively or in addition the filler may also be used to improve scratch resistance or for crack deflection (platelet- or needle-shaped) as explained above. Crack deflection in particular may for example help to at least partially minimize or ameliorate the consequences of the resulting crack energy, so that the overall mechanical properties of the glass pane together with the first coating comprising the addition or else together with the first coating comprising the addition and the intermediate layer are substantially retained or at least not markedly reduced.

However, a different configuration of an addition is also possible alternatively or in addition. So-called foaming agents may be used for example. These are compositions which when heated during baking of the coating decompose to form a fluid phase, preferably a gas phase. This may form bubbles in the coating. Such bubbles or pores in a coating can likewise reduce the coefficient of thermal expansion of the coating. Known foaming agents are for example generally carbonates or phosphates but also organic additions such as starch or sugar.

In a preferred embodiment the coating thus comprises an addition, wherein the addition is a filler or a foaming agent (also referred to as a blowing agent). It is especially also possible for the coating to comprise two or more addition, for example a filler and a foaming agent or else two or more fillers and/or two or more foaming agents.

In yet a further embodiment the glass pane has a thickness between at least 1 mm and at most 12 mm.

In yet a further embodiment the binder comprises a glass frit or consists thereof, wherein the glass frit preferably comprises a coloring constituent and/or wherein the proportion of the pigment in the respective first coating particularly preferably comprises at most 40% by volume, preferably at most 20% by volume. It may preferably be provided that the glass frit comprising a coloring constituent is combined with a pigment proportion of at most 40% by volume, preferably 20% by volume.

Such a configuration of the coating and accordingly of the glass pane may be advantageous when the pigment content of the coating is to be kept low. This may be desired for several reasons. Pigments are generally relatively high cost components, especially those having a high color strength. It may therefore be advantageous for a coating to have the lowest possible proportion of pigments.

Furthermore, ceramic pigments typically used in a coating can exhibit relatively high coefficients of thermal expansion compared to borosilicate glasses, for example spinel-based pigments. It can also be advantageous to limit the content of pigments in a coating from a standpoint of avoiding an excessively high coefficient of thermal expansion of the respective coating.

However, this may be disadvantageous from the standpoint of the hiding power of the resulting coating. This is because an excessively low content of pigment can have the result that a coating of insufficient opacity is obtained or that the coating would have to have a very high layer thickness to be opaque. However, excessively high layer thicknesses are disadvantageous not only for cost reasons (due to the high material usage) but can also result in flaking and cracking.

It may therefore be advantageous in the case of only low pigment contents in the coating, in particular the first coating, to select the binder, in particular a glass frit, such that it comprises a coloring constituent. This is because the glass frit then also contributes to the hiding power of the coating. It may also be the case that disruptive colorings brought about by the pigment (for example an undesired brown cast, which occurs in black pigments relatively frequently) can be actively counteracted by the glass frit, thus affording a particularly neutrally dark, black color impression. Especially for coatings used in glass laminates in the automotive sector this is also an advantage for driving safety. This is because a driver is not disruptively distracted by a uniform color impression in the border region of a window.

In a further aspect of the disclosure also relates to a paste. This is a paste for producing a coating on a glass pane, preferably a first coating on a glass pane, such as is described according to embodiments of the present disclosure.

The paste comprises at least one binder comprising SiO₂ and at least one pigment, preferably at least one dispersion medium.

The medium or dispersion medium is advantageous for applying the paste to the glass pane, for example for applying the paste by means of a screen printing process.

The binder comprises a glass frit or consists thereof, wherein the glass frit comprises a glass comprising at least the following constituents in % by weight based on oxide:

| | |
|---|---|
| SiO₂ | 10 to 70 |
| B₂O₃ | 10 to 26 |
| Al₂O₃ | more than 0 to 9. |

In the case of high-Bi frits, in particular high-Bi borosilicate frits, the glass frit may comprise a glass comprising at least the following constituents in % by weight based on oxide:

Ranges for high-Bi borosilicate frits

| | | |
|---|---|---|
| Bi₂O₃ | 8-45 | |
| B₂O₃ | 15-25 | |
| SiO₂ | 30-60 | |
| Sum of R₂O | 4-5 | Alkali metal oxides |
| Sum of RO | <0.5 | Alkaline earth metal oxides |

The frits specified in the preceding paragraph may optionally comprise a proportion of Al₂O₃ of more than 0% to 9% by weight.

For the coefficients of thermal expansion α and the optical density the following applies for the abovementioned high-Bi borosilicate frits:

| | |
|---|---|
| α [*10⁻⁶/K] | Density [g/cm³] |

| min | max | min | max |
|---|---|---|---|
| 4.7 | 7.9 | 2.4 | 4 |

In the case of high-Zn frits, in particular high-Zn borosilicate frits, the glass frit may comprise a glass comprising at least the following constituents in % by weight based on oxide:

Ranges for high-Zn borosilicate frits

| | | |
|---|---|---|
| ZnO | >50 | |
| B₂O₃ | 10-26 | |
| SiO₂ | 10-50 | |
| Sum of R₂O | <0.5 | Alkali metal oxides |
| Sum of RO | <0.5 | Alkaline earth metal oxides |

The frits specified in the preceding paragraph may optionally comprise a proportion of Al₂O₃ of more than 0% to 9% by weight.

For the coefficients of thermal expansion α and the optical density the following applies for the abovementioned high-Zn borosilicate frits:

| | |
|---|---|
| α [*10⁻⁶/K] | Density [g/cm³] |

| min | max | min | max |
|---|---|---|---|
| 3.5 | 5.5 | 3.2 | 4 |

In the case of borosilicate frits the glass frit may comprise a glass comprising at least the following constituents in % by weight based on oxide:

Ranges for “borosilicate” frits

| | | |
|---|---|---|
| Bi₂O₃ | 0-15 | |
| ZnO | 0-5 | |
| B₂O₃ | 15-26 | |
| SiO₂ | 50-70 | |
| Sum of R₂O | 4-6.5 | Alkali metal oxides |
| Sum of RO | 0-2.5 | Alkaline earth metal oxides |

The frits specified in the preceding paragraph may optionally comprise a proportion of Al₂O₃ of more than 0% to 9% by weight.

For the coefficient of thermal expansion α and the optical density the following applies for the above borosilicate frits:

| | |
|---|---|
| α [*10⁻⁶/K] | Density [g/cm³] |

| min | max | min | max |
|---|---|---|---|
| 4 | 5.2 | 2.2 | 2.6 |

The paste is thus in a form such that an enamel coating is obtainable therefrom, wherein the glass frit in each case advantageously comprises a borosilicate glass.

In the context of the present disclosure a paste is in particular to be understood as meaning a so-called decorative or color paste. In particular for the first coating according to the present disclosure the paste generally comprises a glass frit (or a glass flux), at least one pigment and in addition preferably at least one fluid phase also referred to in the context of the present invention as a medium or dispersion medium.

As the medium for screen printable coating solutions it is preferable to employ solvents having a vapor pressure of less than 10 bar, in particular of less than 5 bar and very particularly of less than 1 bar. These may be for example combinations of water, n-butanol, diethylene glycol monoethyl ether, tripropylene glycol monomethyl ether, terpineol, n-butyl acetate. Appropriate organic and inorganic additives are used to be able to establish the desired viscosity. Organic additives may be for instance hydroxyethyl cellulose and/or hydroxypropyl cellulose and/or xanthan gum and/or polyvinyl alcohol and/or polyethylene alcohol and/or polyethylene glycol, block copolymers and/or try block copolymers and/or tree gums and/or polyacrylates and/or polymethacrylates. Commercially available screen printing media based for example on glycol or terpineol or others are generally suitable.

According to embodiments the paste may generally be used to afford a glass pane having a coating, wherein the coating is an enamel layer and comprises a binder, here in the form of a glass frit (or glass flux), which comprises the following constituents in % by weight based on oxide:

| | |
|---|---|
| SiO₂ | 10 to 70 |
| B₂O₃ | 10 to 26 |
| Al₂O₃ | more than 0 to 9. |

The glass flux or the glass frit of a paste thus generally forms the binder in the coating resulting from the paste, at least in the “pure” enamel layers. It is generally also possible for the coating to comprise not only a gas frit but also another glass-based binder not composed of a glass frit or derived therefrom, for example a sol-gel-based binder. In this case the binder of the coating is formed from the different binders as a mixture.

A paste as described above, in particular comprising or consisting of a glass frit comprising a glass comprising at least the following constituents in % by weight based on oxide:

| | |
|---|---|
| SiO₂ | 10 to 70 |
| B₂O₃ | 10 to 26 |
| Al₂O₃ | more than 0 to 9. |

can be advantageous especially because this affords a binder of the coating which is itself in the form of a borosilicate glass. Such borosilicate glasses cannot simply be configured such that they have a relatively low melting point (here B₂O₃ advantageously acts as a so-called flux which reduces the melting temperature and simultaneously ensures that the binder flows readily and can readily encapsulate the solids particles, i.e., in particular the pigment particles and filler particles comprised by the coating/the paste) but also exhibit quite a high chemical resistance as explained above. Such a glass frits/the binder resulting therefrom moreover show good compatibility with a substrate formed from borosilicate glass, i.e., in particular the glass panes described here.

The paste is preferably configured such that it has a viscosity, preferably determined by means of a plate viscometer, between 1500 and 8000 mPas, preferably between 2000 mPas and 6500 mPas and particularly preferably between 2500 mPas and 5000 mPas. In this way the paste is readily appliable to substrates, in particular to glass panes, on an industrial scale by customary application methods. The paste may advantageously be applied to the substrate, i.e., the glass pane, by means of a printing process, in particular by screen printing.

However, it may also be provided to adjust the viscosity differently, so that for example a low viscosity is obtained, i.e., for example a viscosity of at most 1500 mPas.

The paste is preferably configured such that the glass frit comprised by the paste has a linear coefficient of thermal expansion between at least 2*10⁻⁶/K and at most 10*10⁻⁶/K, preferably between at least 3*10⁻⁶/K and at most 6*10⁻⁶/K. This makes it possible to obtain coatings which advantageously allow a sufficient strength of the glass pane, particularly in the case of preferably opaque coatings. Coefficients of thermal expansion in the range between at least 3*10⁻⁶/K and at most 6*10⁻⁶/K in particular are advantageous here, since these provide a particularly good match for known borosilicate glasses in terms of the coefficient of thermal expansion.

In a further embodiment the paste comprises between 0.5% by volume and 50% by volume of pigment, preferably not more than 40% by volume of pigment, especially particularly preferably between 20% and 40% by volume of pigment, based on the solids content comprised by the paste.

The content of glass frit in the paste is between 99.5% by volume and 50% by volume, preferably between 99.5% and 60% by volume, especially preferably between 80% and 60% by volume, based on the solids content comprised by the paste.

This is because this makes it possible—in particular for the thicknesses of the coating presently disclosed—to obtain coatings exhibiting a sufficient hiding power (or opacity) coupled with sufficient scratch resistance and adhesion of the coating.

When the coating, in particular the first coating, also comprises an addition, in particular a filler, in addition to the pigment and the binder, the volume fraction of the binder preferably remains within the abovementioned limits. In other words the binder content preferably remains between 99.5% by volume and 30% by volume of glass frit. This is because the addition, in particular in the form of the filler, does not serve to form a bond between the particles of the coating and the bond thereof to the substrate but rather itself belongs to the particulate constituent of the coating. The coating/the paste may therefore be configured such that it generally comprises 99.5% by volume and 50% by volume of glass frit, preferably between 99.5% by volume and 60% by volume of glass frit, wherein the volume fractions are here in each case based on the solids content of the paste. The paste comprises not only the solids formed by the binder and the at least one pigment or optionally the sum of the pigments and optionally an addition or else two or more addition but also further constituents such as for example a solvent and optionally also an additive. The proportion of addition in the form of filler is preferably at most 25% by volume and particularly preferably at least 0.1% by volume. Preferred upper limits for the filler may be 20% by volume or 15% by volume, wherein preferred lower limits may be 1% by volume and 5% by volume. The volume fractions are here in each case based on the solids content of the paste. When the paste and/or the coating comprises two or more additions in the form of fillers the total content of filler is used. The proportion of pigment is between 0.5% by volume and 50% by volume of pigment, preferably not more than 40% by volume of pigment, especially particularly preferably between 20% and 40% by volume of pigment, wherein the volume fractions are here in each case based on the solids content of the paste. When the paste comprises two or more pigments the sum of the pigment content is used.

In one embodiment the paste may further be configured such that it comprises an addition, wherein the addition is configured to reduce the linear coefficient of thermal expansion of the coating relative to a composition of the coating without the addition, wherein the addition is preferably a blowing agent or a filler, wherein the addition is particularly preferably a filler having a linear coefficient of thermal expansion between −10*10⁻⁶/K and +10*10⁻⁶/K. It is preferable when the linear coefficient of thermal expansion is between −8*10⁻⁶/K and +5*10⁻⁶/K, particularly preferably between −6.5*10⁻⁶/K and +3*10⁻⁶/K.

This embodiment may be advantageous especially when the coating is configured such that it comprises two or more additions in the form of fillers and the first addition in the form of a filler comprised by the coating itself has a different coefficient of thermal expansion, for example because the filler serves to improve other properties of the coating, for example to improve scratch resistance.

In a preferred embodiment the paste is configured such that the glass frit comprises a coloring constituent. In other words the glass frit is here configured such that it does not comprise or consist of uncolored glass but rather is colored, preferably volume-colored, i.e., colored by coloring ions or colored by crystal phases formed upon frit production or upon baking of the color. Such a configuration is advantageous especially at low pigment contents, as also described in detail hereinabove.

It is noted here that the paste and the respective coating are formed in a relationship to one another such that the respective coating is formed from the solids constituent of the paste. In other words the respective coating comprises the binder present in the paste as glass frit and the particulate constituents, in particular the at least one pigment and optionally two or more pigments and/or additions, for example fillers. The coating comprises any fluid constituents of the paste, such as solvent, only in traces, if at all, since these are baked out during baking.

It is generally noted that it is presently also possible to obtain the first coating via a paste which comprises no glass frit or not only glass frit as binder but rather a sol-gel-based binder for example. However such a configuration is generally not preferred since such pastes have a tendency to be more difficult to process than pastes comprising only a glass frit as binder. In particular the pot life of such sol-gel-based/sol-gel-comprising pastes is generally low and the viscosity may be disadvantageous for customary industrial scale application processes, for example screen printing.

A further aspect of the present disclosure relates to a laminate comprising an at least partially coated glass pane according to an embodiment of the disclosure and a further glass pane, wherein the coating is preferably arranged between the glass panes. The laminate preferably further comprises a polymeric ply which is likewise arranged between the glass panes and bonds these to one another. The polymeric ply may for example be in the form of a film between the two glass panes but it is also possible to apply the polymeric ply initially in liquid form, wherein the polymeric liquid cures to afford a polymeric ply during bonding of the two glass panes.

The mechanical strength/the quality of the laminate is generally tested in the so-called “pummel test”. It is generally the case that upon destruction of the laminate, which may for example also be referred to as “laminated safety glass”, the glass shards must remain adhered to the polymeric ply, for example in the form of a PVB film, between the glass panes of the laminate. This is tested with the “pummel test” in which a laminated glass comprising two glass panes having a maximum thickness of 2*4 mm is worked over with a hammer on an inclined metal base (to pummel=to strike). The mechanical influence destroys the glass. Visual assessment follows. The adhesion level of each revealed film area/revealed area of the polymeric ply is assigned “pummel values” between 0 and 10, wherein higher values represent better adhesion of the glass shards to the polymeric ply.

If the polymeric ply is formed from PVB the specimen is first cooled to −18° C. since otherwise the glass shards would be pressed into the polymeric ply. If the glass panes of the specimen are each float glass panes, both glass panes of the laminated glass are tested. This is because it has been found that the so-called “tin bath sides” give poorer values in the pummel test than the fire sides, i.e., the top side of the glass pane formed in the float process.

### EXAMPLES

The invention is hereinbelow more particularly elucidated with reference to examples.

The glass pane according to the present disclosure comprises a glass comprising SiO₂ and B₂O₃.

In a first exemplary embodiment the glass may be constituted by a composition comprising the following components, each reported in % by weight based on oxide:

| | |
|---|---|
| SiO₂ | 60 to 85, particularly preferably up to 82 |
| B₂O₃ | 7 to 26 |
| Al₂O₃ | 0 to 12, preferably more than 0 to 11, |
| | particularly preferably up to 7 |
| Li₂O | 0 to 1 |
| Na₂O | 0.5 to 6 |
| K₂O | 0 to 3 |
| MgO | 0 to 6 |
| CaO | 0 to 5 |
| SrO | 0 to 4 |
| ZnO | 0 to 3 |
| ZrO₂ | 0 to 3. |

Other constituents, such as are typically employed in glass production, may also be comprised, for example refining agents. These are generally comprised in a content of not more than 2% by weight of glass.

In the following compositions deviations from 100% in the total weight fraction may occur due to analytical rounding errors.

An exemplary glass is constituted in the following composition range in % by weight based on oxide:

| | |
|---|---|
| SiO₂ | 75-85 |
| B₂O₃ | 10-15 |
| Al₂O₃ | 1-3 |
| Na₂O | 2-5 |
| K₂O | 0-1 |
| NaCl | less than 0.5 |

An exemplary composition of a glass in this composition range in % by weight based on oxide is constituted as follows:

| | |
|---|---|
| SiO₂ | 80.8 |
| B₂O₃ | 12.7 |
| Al₂O₃ | 2.4 |
| Na₂O | 3.5 |
| K₂O | 0.6 |
| NaCl | 0.1 |

A further glass is constituted in the following composition range in % by weight based on oxide:

| | |
|---|---|
| SiO₂ | 73-83 |
| B₂O₃ | 8-12 |
| Al₂O₃ | 1-4 |
| Na₂O | 2-4 |
| K₂O | 1-3 |
| MgO | 1-3 |
| CaO | 1-3 |

A still further exemplary composition of a glass in this composition range in % by weight based on oxide is constituted as follows:

| | |
|---|---|
| SiO₂ | 78.1 |
| B₂O₃ | 9.8 |
| Al₂O₃ | 2.5 |
| Na₂O | 2.8 |
| K₂O | 2.5 |
| MgO | 1.8 |
| CaO | 2.5 |

Such glasses in the above mentioned composition range, in particular having the specific compositions recited by way of example above are advantageous not only because they exhibit coefficients of thermal expansion which may advantageously be between 2*10⁻⁶/K and 6*10⁻⁶/K, depending on the precise composition, but also because they can exhibit sufficient mechanical resistances, for example also towards surface loads.

Such competitions in particular also make it possible to obtain a glass pane which in the uncoated region exhibits only low scattering after a so-called falling gravel test. The falling gravel test is performed as previously elucidated below:

A contain open at the bottom contains gravel particles which enter from the container into a freefall tube and can depart this freefall tube towards a pane, onto which the gravel particles impact with respective particle impulses P_{(falling)} defined by the respective particle mass and the speed Vₘₐₓ gained along the free fall distance F.

To avoid adhesions the gravel particles are in each case dried before performing the falling gravel test to ensure that in each case only a single particle impacts the pane independently of respective other particles and non-cohesive particle agglomerates.

The pane may in each case be arranged at a different angle of inclination α′, wherein this angle of inclination α′ is in each case the angle to a horizontal plane, to which the gravel particles move perpendicularly until they impact the pane in each case.

The abovementioned falling gravel test is in each case performed at a defined angle of inclination α′ until a—previously defined—total amount of gravel particles have impacted the pane.

The damage to the glass surface caused in this test results in scattering/haze which is determinable by analytical means. Measurement of haze/scattering is preferably carried out in each case according to ASTM D1003 (CIE C) with an appropriately calibrated haze measuring instrument, for example the Haze-Gard plus AT-4725 instrument from BYK-Gardner.

Employable here are in particular glass panes which in the uncoated region have a haze value after the falling gravel test as described above of less than 6%, preferably for values of the angle of inclination α′ between 15° and 60°.

Glass panes comprising such classes especially advantageously have uncoated strengths between 100 MPa and 210 MPa, preferably at most 200 MPa.

Such glasses preferably have very high chemical resistances. These may be distinguished for example into acid (A), lye (L) and hydrolytic (H) resistance. In one embodiment the resistance in the classes H, S and L is preferably H=1, S=1, L=1-3. Chemical resistance is in each case determined according to the following standards: hydrolytic resistance according to ISO 719/DIN 12 111 HGB 1; according to ISO 720=HGA 1, i.e., depending on the testing performed H stands for HGA or HGB; acid resistance according to DIN 12 116; but may also be performed according to ISO 1776, wherein values of ≤100 μg Na₂O per 100 cm² are then obtained; lye resistance according to ISO 695/DIN 52322; class A2 is obtained here.

Pigments that may be used generally include ceramic colorants, in particular spinel-based pigments, for example chromium-copper spinels, iron-nickel-chromium spinels or ferrite or hematite. Other oxides, such as iron-manganese oxide or iron-chromium oxides, may in principle be used, for example also TiO₂. Customary pigment sizes may be between on average 0.15 μm to 5 μm, wherein the d₉₀, based on equivalent diameter, may be up to 15 μm. However, finer particles may be preferable since these more readily printable.

Additions may generally be foaming agents for example. In the context of the present disclosure foaming agents may also generally be referred to as blowing agents or pore-formers. Foaming agents that may be employed include starches, for example raise starch, rice starch, wheat starch, potato starch or manioc or mixtures thereof. It is also possible to use sugars for this purpose, for example maltose, glucose, fructose and/or sucrose or mixtures thereof. The recited starches decompose at temperatures around 200° C.; the sugars, by contrast, at lower temperatures between about 100° C. and 150° C. depending on the precise compound.

However, alternatively or in addition, fillers may also be used as additions. These have an average particle size from the nm range to the μm range.

Especially employable here are silicas, for example pyrogenic or precipitated silicas, having particle sizes of less than 1 μm, for example of only 0.1 μm or even less, for example only 0.04 μm, and different surface areas depending on the production process. Silicas are therefore advantageous since they have quite small coefficients of thermal expansion of about 0.5*10⁻⁶/K. It is likewise possible to employ negative-expansion fillers, for example cordierite or β-eucryptite (which has a coefficient of thermal expansion of −1.1 to −6.5*10⁻⁶/K). Such fillers may have for example particle sizes of around 1 μm or more, for example of 1.5 μm or of 1.2 μm.

The fillers are for example round particles having particle sizes, preferably based on the equivalent diameter, in particular the volume-equivalent equivalent diameter, preferably on the d₅₀ of the equivalent diameter, between 1 and 20 μm, preferably between 1 and 5 μm, in order that these do not protrude from the final coating. This may be achieved for example using a quartz glass filler comprising spherical particles, for example the filler used by way of example in the context of the present disclosure, where the particles have diameters between 1 μm and 5 μm. This is a high-purity, spherical quartz glass. However, other quartz, quartz glass and quartz precursor spheres may also be used as fillers.

It is also possible to use special, porous fillers. Preferred examples are porous glasses, such as are obtainable for example under the name “CoralPor®”, and porous crystalline materials. The fillers marketed under the brand “CoralPor” and used here are borosilicate glasses which have been subjected to thermal and chemical treatment such that an open porosity is specifically established. It is generally also possible to employ nanoporous and macroporous multicomponent glasses having low coefficients of expansion and a rigid amorphous microstructure as porous glasses. Other low-expansion porous glass powders are in principle also suitable, not only the CoralPor® products presently used by way of example. One example of porous crystalline materials are those based on zeolite.

The filler may also be formed in situ, for example by decomposition of an organometallic or organosilicon component. This was presently demonstrated by way of example by addition of the silicone resin marketed under the Silres® brand. This is a silicone resin which is converted into SiOC upon heating and thus results in a grayish filler. Other decomposable silicone resins are in principle also suitable in addition to Silres®.

A number of exemplary frit compositions are summarized below. In the following table the components are reported in % by weight based on oxide. Other constituents, such as are typically employed in glass production, may also be comprised, for example refining agents.

These are generally comprised in a content of not more than 2% by weight of glass.

| Example | 1 | 2 | 3 | 4 | 5 | 6 | 7 | 8 | 9 | 10 | 11 |
|---|---|---|---|---|---|---|---|---|---|---|---|
| Al₂O₃ | 8.2 | 7.2 | 5.4 | 0.6 | 5.9 | 0.10 | 1.00 | 5.1 | 5.3 | 5.0 | 2.0 |
| B₂O₃ | 18 | 22.8 | 24.0 | 24.6 | 21.5 | 15.70 | 12.75 | 21.9 | 22.9 | 23.4 | 8.3 |
| BaO | | | | | | | | | | | |
| Bi₂O₃ | 14 | 10.0 | 10.0 | | | | | | | 11.0 | 43.25 |
| CaO | | | | 1.3 | 1.2 | | | 0.5 | 0.5 | | 0.1 |
| CoO | | | | | 2.9 | | | | | | |
| K₂O | | | | 0.1 | | | | 1.7 | 1.8 | 0.8 | 1.75 |
| Li₂O | | 3.2 | 4.4 | | 4.9 | | | 0.8 | 0.8 | 4.8 | 0.8 |
| MgO | | | | 0.3 | | | | | | | |
| Na₂O | 5.2 | 1.2 | 0.2 | 6.1 | | | | 2.4 | 2.5 | | 2.75 |
| SiO₂ | 55 | 55.6 | 56.0 | 66.6 | 58.0 | 32.70 | 24.25 | 63.4 | 66.2 | 55.0 | 29.5 |
| SrO | | | | | 1.0 | | | | | | |
| TiO₂ | | | | | | | | | | | 1.6 |
| ZnO | | | | 0.4 | 3.3 | 51.50 | 62.00 | | | | 8.9 |

A number of coating compositions of the first coating and a number of paste compositions with and without additions are summarized below.

Coatings produced, in particular first coatings having these frit compositions, showed that either a low pigment content (<7.5% by volume) or a relatively high pigment content (≥20% by volume) can be advantageous for the mechanical properties of the at least partially coated pane. In the first case the α-mismatch, i.e., the difference in the coefficients of thermal expansion, between the coating, in particular the first coating, and the glass pane is advantageous and in the latter case pores are formed in the coating, in particular in the first coating, which are advantageous up to a content of 37.5% by volume. At greater contents the coating is generally too porous for the purposes of the present invention.

The table which follows summarizes exemplary coating compositions for the first coating comprising a binder, here a glass frit, and pigment.

Layers Only with Pigment

| | |
|---|---|
| Layer | Layer |
| (% by volume) | (% by weight) |

| Example | Frit | Pigment | Frit | Pigment |
|---|---|---|---|---|
| 1 | 65 | 35 | 45.5 | 54.5 |
| 2 | 80 | 20 | 64.1 | 35.9 |
| 3 | 90 | 10 | 80.2 | 19.8 |
| 4 | 92.5 | 7.5 | 84.7 | 15.3 |

Coatings are obtainable with the following pastes (the numbering of the pastes and the coatings corresponds):

| | Pastes (% by weight) | | |
|---|---|---|---|
| Ex. | Frit 3 | Spinel pigment | Medium |
| 1 | 32.51 | 38.96 | 28.53 |
| 2 | 45.5 | 25.5 | 29 |
| 3 | 56.8 | 14.0 | 29.3 |
| 4 | 59.8 | 10.8 | 29.3 |

FIG. 4 shows a corresponding representation of the results of the measurements of flexural tensile strength on different glass panes coated according to the present disclosure, wherein the content of the frit and the pigments was varied in each case for the different measurement points. Flexural tensile strength was in each case determined by the double ring method according to DIN 1288-5. The respective region of the glass pane subjected to the measurement was in each case coated all over so that uncoated regions of the glass pane had essentially no influence on the measured results. The effect of the proportion of the pigments on flexural tensile strength in particular is readily apparent from this figure.

Addition of low-expansion fillers surprisingly results in an increase in mechanical strength even at low additions. Addition of more than 30% by volume of low-expansion filler which is not colored and thus especially not colored in the coating results, at the thicknesses presently disclosed for the coating, in a reduction in the opacity/optical density to below 1.5 and is often not suitable for use. This may be countered with a higher pigment content. This is shown for example in the tables which follow.

Compositions of coatings comprising an addition, here always filler, are reported in the following table:

| | | Layer % by volume | | | Layer % by weight | | |
|---|---|---|---|---|---|---|---|
| No. | | Frit | Pigment | Filler | Frit | Pigment | Filler |
| 5 | 1.25% by | 75.5 | 23.25 | 1.25 | 58.8 | 40.1 | 1.1 |
| | volume of | | | | | | |
| | extra filler | | | | | | |
| 6 | 10% by | 69.5 | 21.4 | 9 | 55.5 | 37.9 | 6.6 |
| | volume of | | | | | | |
| | extra filler | | | | | | |
| 7 | Pigment | 76.5 | 13.5 | 10 | 66.2 | 26 | 7.8 |
| | variation + | | | | | | |
| | 10% by | | | | | | |
| | volume of | | | | | | |
| | filler | | | | | | |
| 8 | Pigment | 65 | 15 | 20 | 55.8 | 28.6 | 15.6 |
| | variation + | | | | | | |
| | 10% by | | | | | | |
| | volume of | | | | | | |
| | filler | | | | | | |

| | | Layer % by volume | | | |
|---|---|---|---|---|---|
| No. | | Frit | Pigment | Filler | Optical density |
| 9 | Silica filler | 75.6 | 23.2 | 1.2 | 2.9 |
| 10 | β-Eucryptite | 75.6 | 23.2 | 1.2 | 2.3 |
| | filler | | | | |
| 11 | Porous glass | 75.6 | 23.2 | 1.2 | 2.3 |
| | filler | | | | |
| 12 | β-Eucryptite | 66.55 | 20.45 | 13 | 1.7 |
| | filler | | | | |
| 13 | Silica filler | 66.55 | 20.45 | 13 | 1.4 |
| 14 | Quartz glass | 66.55 | 20.45 | 13 | 1.7 |
| | spheres | | | | |
| 15 | Silica filler | 55 | 35 | 10 | 2.6 |
| 16 | Silica filler | 60 | 30 | 10 | 2.2 |
| 17 | Silicone | 75.6 | 23.2 | 1.2 | 1.8 |
| | resin/SiOC filler | | | | |
| 18 | Silicone | 72.8 | 22.4 | 4.8 | 1.8 |
| | resin/SiOC filler | | | | |
| 19 | Silicone | 66.5 | 20.5 | 13 | 1.9 |
| | resin/SiOC filler | | | | |
| A | Comparison | 76.5 | 23.5 | — | 2.5 |
| B | Comparison | 65 | 35 | — | 3 |

Such coatings are obtainable with pastes such as are specified in the following table (here too the numbering of the coating and the paste for production thereof corresponds):

Pastes (% by weight)

| | Frit | Pigment | Filler | Medium |
|---|---|---|---|---|
| 5 | 40.60 | 27.70 | 0.7 | 31.00 |
| 6 | 37.5 | 25.6 | 4.4 | 32.5 |
| 7 | 44.7 | 17.6 | 5.3 | 32.4 |
| 8 | 37.5 | 19.2 | 10.4 | 32.9 |

FIG. 5 shows a corresponding representation of the results of measurements of flexural tensile strength on different glass panes coated according to the present disclosure, wherein different fillers, namely a pyrogenic silica, β-eucryptite and CoralPor® were used for the different measurement points, in each case at a proportion of 1.25% by volume. Flexural tensile strength was in each case determined by the double ring method according to DIN 1288-5. The respective region of the glass pane subjected to the measurement was in each case coated all over so that uncoated regions of the glass pane had essentially no influence on the measured results. The effect of the proportion of the pigments on flexural tensile strength in particular is readily apparent from this figure.

Coatings 20 to 23, which comprise a blowing agent as an addition, are summarized in the following table. Addition of the blowing agent is calculated such that the additional porosity reported in the first column results.

| | | Layer % by volume | | | Layer % by volume | | | Layer % by weight | | |
|---|---|---|---|---|---|---|---|---|---|---|
| | | (without pores) | | | (with pores) | | | (with pores) | | |
| | | | | Blowing | | | Blowing | | | Blowing |
| | Porosity | Frit | Pigment | agent | Frit | Pigment | agent | Frit | Pigment | agent |
| 20 | 5% by volume | 75 | 25 | 5 | 71.4 | 23.8 | 4.8 | 56.1 | 41.6 | 2.3 |
| 21 | 10% by volume | 76.5 | 23.5 | 10 | 69.5 | 21.4 | 9.1 | 56.7 | 38.7 | 4.6 |
| 22 | 20% by volume | 82.5 | 17.5 | 20 | 68.7 | 14.6 | 16.7 | 61.7 | 29.1 | 9.2 |
| 23 | 25% by volume | 80 | 20 | 25 | 64 | 16 | 20 | 57.2 | 31.8 | 11 |

Such coatings are obtainable with pastes 20 to 23 in the following table. The numbering of the pastes 20 to 23 disclosed below in each case corresponds to the numbering of the coatings in the abovementioned table.

Pastes (% by weight) (including pore former)

| | | | blowing agent/ | |
|---|---|---|---|---|
| Paste no. | Frit | Pigment | pore former | Medium |
| 20 | 37.9 | 28.1 | 1.6 | 32.4 |
| 21 | 39.1 | 26.7 | 3.2 | 31 |
| 22 | 41.7 | 19.7 | 6.2 | 32.4 |
| 23 | 38.1 | 21.2 | 7.4 | 33.3 |

The addition of foaming agent or blowing agent introduces a specific, closed porosity into the first coating. The pores must be small enough to remain in the selected layer thickness, i.e., in the selected thickness of the first coating and in the further embodiment the first fitness together with the thickness of the intermediate layer. Increasing pore addition to above 25% by volume results in a fuzzy appearance and in a reduction in opacity.

FIG. 6 shows a corresponding representation of the results of two measurements of flexural tensile strength on different glass panes coated according to the present disclosure, wherein rice starch was used as blowing agent for the first measurement point and sugar was used as blowing agent for the second measurement point, in each case at a proportion of 10% by volume. Flexural tensile strength was in each case determined by the double ring method according to DIN 1288-5. The respective region of the glass pane subjected to the measurement was in each case coated all over so that uncoated regions of the glass pane had essentially no influence on the measured results. The effect of the proportion of the pigments on flexural tensile strength in particular is readily apparent from this figure.

It has been found that even a filler content of not less than 1.0% by volume based on the solids content can be highly advantageous for increasing the strength of the glass pane relative to coatings comprising no filler. As explained above, a potential insufficient optical density due to filler content may be compensated by increasing the pigment content.

The addition content, in particular the filler content, may generally be up to 20% by volume or even up to 25% by volume or even up to 27% by volume, here too based on the total solids content of the coating. It has moreover generally been found that it is advantageous when the pigment content of the coating is high relative to the addition, in particular the filler employed, for example the volume ratio of addition to pigment, in particular filler to pigment, is in general between 1:2 and 1:7, preferably between, in particular the content of filler to pigment, 1:2 and 1:5, preferably between 1:3 and 1:4. Despite this ratio, it is surprisingly the case that the color coordinates of such layers do not markedly deviate from those, where a low ratio of addition to pigment, in particular of filler to pigment was established or where no addition, for example no filler at all was added.

Particularly advantageous properties are obtainable when high contents of pigments, i.e., for example of almost 40% by volume, are combined with intermediate contents of fillers, i.e., for example of 8% to 15% by volume. These figures relate generally to all pigments and fillers employed, i.e., to the total content of the coating of pigment and filler. This advantageously results in a particularly high strength of the glass pane coupled with a scratch resistance/abrasion resistance of the resulting coating which is surprisingly still sufficient.

The following table lists a number of compositions of coatings according to embodiments which have proven particularly advantageous. The figures in the following table are based on the volume of the resulting coating and are therefore reported in % by volume. The fillers employed were a pyrogenic silica, β-eucryptite, a porous filler (CoralPor®) and the fillers quartz glass spheres (d₅₀ between 1 and 5 μm) and silicone resin (Silres®) which decomposes to a solid (SiOC).

Filler

| No. | Frit | Pigment | Type | Amount |
|---|---|---|---|---|
| 24 | 75.6 | 23.2 | Silica | 1.2 |
| 25 | 75.6 | 23.2 | β-Eucryptite | 1.2 |
| 26 | 75.6 | 23.2 | CoralPor ® | 1.2 |
| 27 | 66.6 | 20.4 | β-Eucryptite | 13 |
| 28 | 66.6 | 20.4 | Silica | 13 |
| 29 | 66.6 | 20.4 | Quartz glass spheres | 13 |
| 30 | 55 | 35 | Silica | 10 |
| 31 | 60 | 30 | Silica | 10 |
| 32 | 75.6 | 23.2 | Silicone resin | 1.2 |
| 33 | 72.8 | 22.4 | Silicone resin | 4.8 |
| 34 | 66.5 | 20.5 | Silicone resin | 13 |
| 35 | 60 | 35 | Silica | 5 |

### BRIEF DESCRIPTION OF THE FIGURES

The invention is hereinbelow more particularly elucidated with reference to the figures. In the figures:

FIG. 1 shows a schematic representation (not to scale) of a laminate according to one embodiment;

FIGS. 2 and 3 show schematic representations (not to scale) of a glass pane according to one embodiment,

FIG. 4 shows the results of measurements of flexural tensile strength on different glass panes coated according to the present disclosure, wherein the content of the frit and the pigments was varied in each case for the different measurement points,

FIG. 5 shows the results of flexural tensile strength measurements on different glass panes coated according to the present disclosure, wherein different fillers, namely pyrogenic silica, β-eucryptite and CoralPor® were used for the different measurement points, in each case at a proportion of 1.25% by volume.

FIG. 6 shows the results of two measurements of flexural tensile strength measurements on different glass panes coated according to the present disclosure, wherein rice starch was used as blowing agent for the first measurement point and sugar was used as blowing agent for the second measurement point, in each case at a proportion of 10% by volume.

FIGS. 7 to 12 show diagrams relating to the effect of filler and pigment contents in coatings on different coating/pane properties; and

FIG. 13 shows scanning electron micrographs of different coated glass panes.

### DETAILED DESCRIPTION

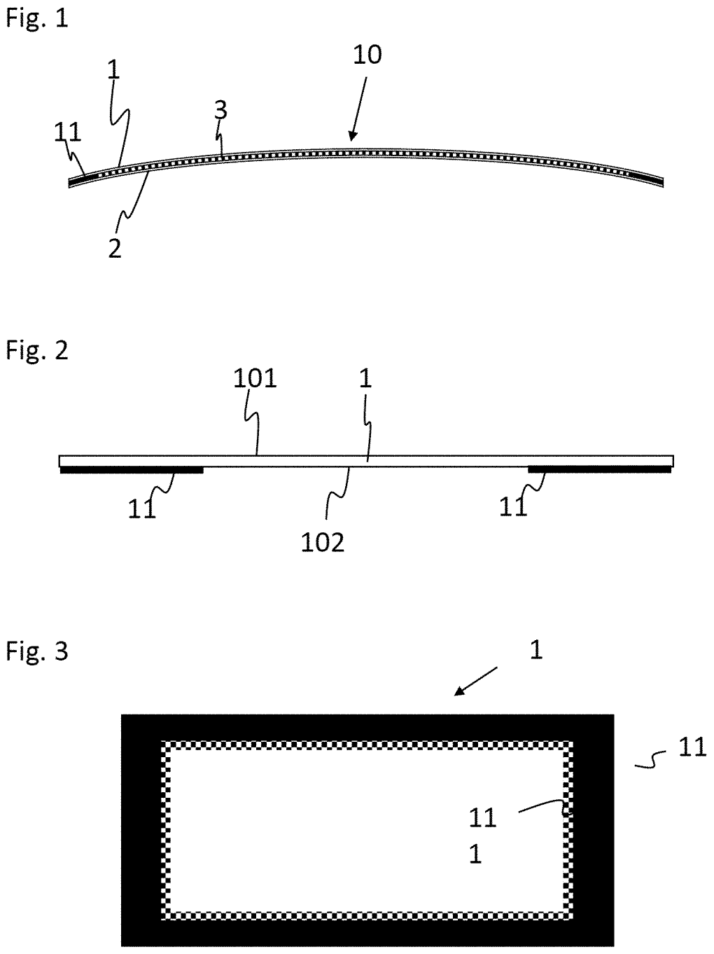

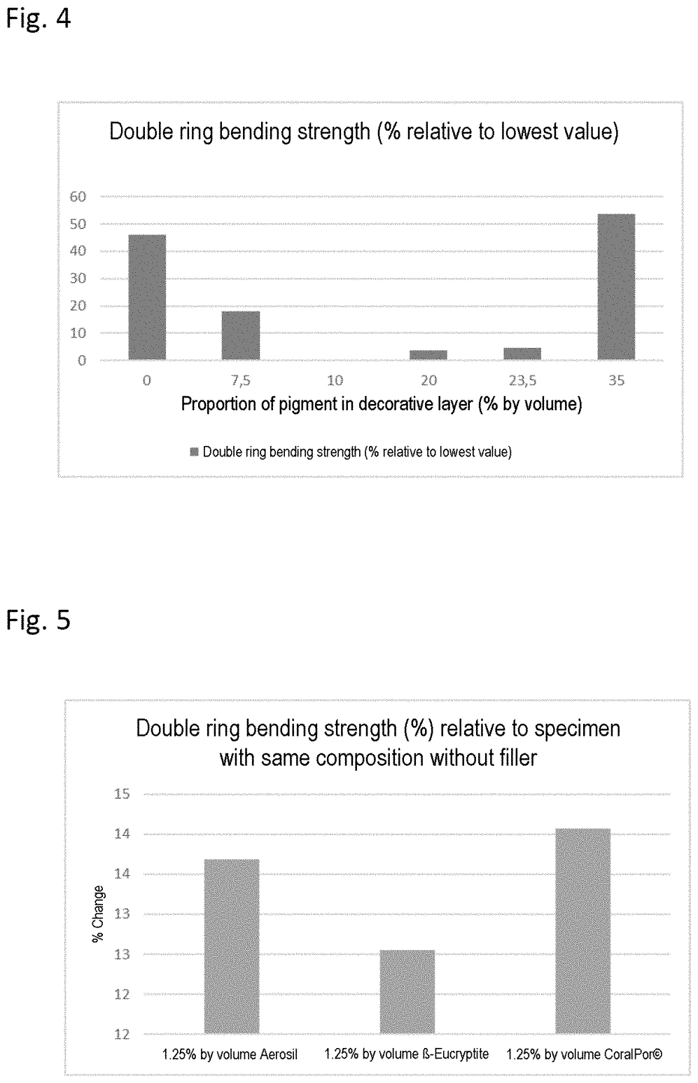

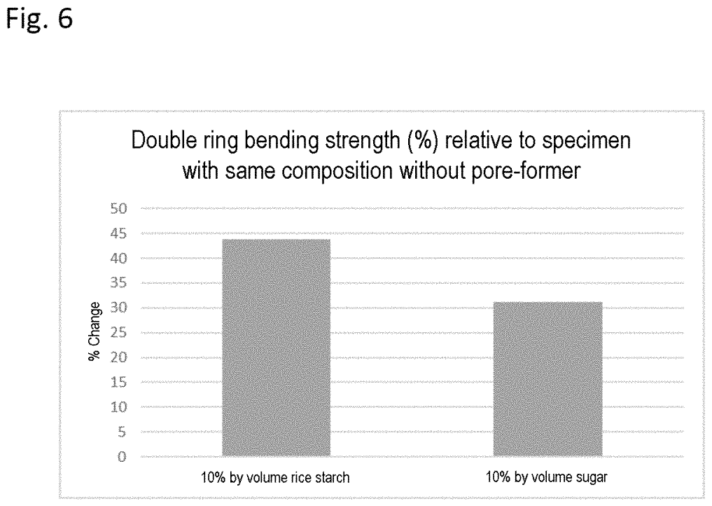

FIG. 1 is a schematic representation (not to scale) of a laminate/a laminated glass pane 10 according to one embodiment of the present disclosure. The laminate 10 comprises two panes 1, 2, wherein pane 1 is a glass pane for a vehicle according to one embodiment of the present disclosure. Pane 2 is a further glass pane and may be composed for example of a soda lime glass or else of the presently disclosed glass of pane 1. Arranged between the two glass panes 1, 2 is a polymeric ply 3 and, here in the border region of the laminate 10, the coating 11. Said coating is arranged on one side (not described) of the glass pane 1 and in each case in the context of the description which follows can comprise the first coating or the first coating together with the further coating as an intermediate layer.

For ease of representation the coating 11 is represented as thick, i.e., comparable in thickness with the two panes 1, 2, but, as mentioned, this is only for ease of representation thereof. The coating 11 is generally markedly thinner than each of the two panes 1 and 2 and generally also thinner than the polymeric ply 3. The polymeric ply 3 may also be a film.

As is apparent, the laminate 10 is presently in the form of a curved laminated glass pane such as may be used as a windshield for example. However, it is generally also possible, without limitation to the example shown in FIG. 1, for the laminate 10 not to comprise bent panes 1, 2 and to be flat. It is also possible for the curve of the laminate 10 to be precisely opposite to that which is shown FIG. 1. In the example of FIG. 1 glass pane 1 would be the outside of the windshield but it is generally also possible for glass pane 1 to be arranged on the inside of the windshield. However, in any event the coating 3 is arranged between the two glass panes 1, 2.

However, an arrangement as in FIG. 1 may be advantageous since the glass pane 1 comprises SiO₂ and B₂O₃ as components of the glassy material. Such a borosilicate glass is more scratch resistant than for example a soda lime glass and it may therefore be advantageous when, as shown in FIG. 1, the glass pane 1 is configured in the laminate 10 such that it faces “outwards”, i.e., would face outwards if used as a windshield. This is because this would ensure better protection from stone impacts and similar mechanical stresses.

To elucidate the construction of the glass pane 1 according to embodiments this is shown in the form of a schematic figure (not to scale) in FIGS. 2 and 3. FIG. 2 shows a side view. The glass pane 1 is not yet bent here. However, it is generally also possible, without limitation to the example of a glass pane 1 shown in FIG. 1, for the glass pane to be bent. However, it may be advantageous to initially use a flat, unbent pane 1 which is then bent later, for example in a thermal process. Here too, the thickness of the coating 11 is shown as markedly greater than in reality for ease of representation.

The arrangement of the pane 1 corresponds to that shown in FIG. 1, with the exception that the pane in FIG. 2 is not bent. As is apparent, the coating 11 is in this case on the side 102 facing the second pane 2 in the laminate 10. Not shown here is the polymeric ply 3 which is arranged between pane 1 and pane 2 in the laminate. It is expressly noted here that the polymeric ply 3 not only directly contacts side 102 of the pane but is also arranged on the coating 11 arranged in the region (or regions) of pane 1 (i.e., side 102 of pane 1).

The coating 11 is here arranged in the edge region of pane 1, in the representation of FIG. 2 both on the left-hand and right-hand sides. It may be the case here that the coating is altogether applied in the form of a “border”.

In this regard reference is made to FIG. 3 which, likewise in schematic form and not to scale, shows a plan view of a pane 1 according to an embodiment. The coating 11 is here in the form of a border running around the edge of the pane 1, wherein the coating is initially opaque, i.e., in the form of a layer without interruptions, and towards the middle of the pane 1 transitions via a matrix or dot pattern 111 into the uncoated region. When using the pane 1 in a laminate 10, this uncoated region is the vision area of a windshield for example. It goes without saying that it is generally possible for the border not to be as uniform as shown schematically in FIG. 3 but rather to comprise, for example, convexities, as is often the case in windshields in the region of the rearview mirror for example.

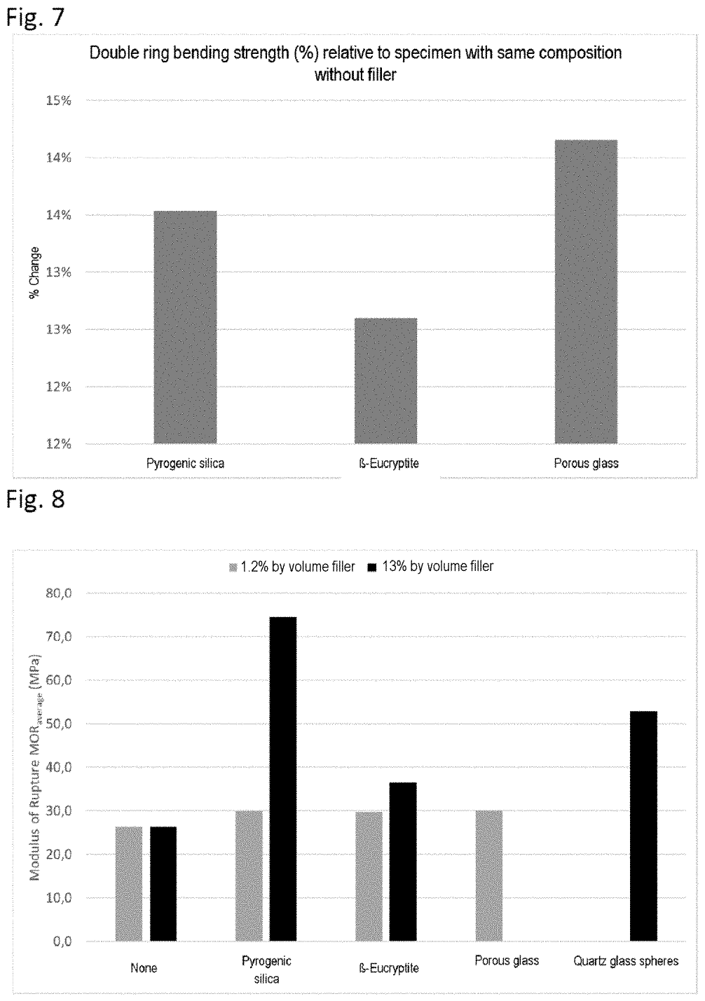

FIG. 7 shows a representation of the change in flexural tensile strength relative to a coated substrate without filler for different glass panes coated according to the present disclosure, wherein different fillers, namely a pyrogenic silica, O-eucryptite and CoralPor® were used, in each case at a proportion of 1.25% by volume. Flexural tensile strength was in each case determined by the double ring method according to DIN 1288-5. The respective region of the glass pane subjected to the measurement was in each case coated all over so that uncoated regions of the glass pane had essentially no influence on the measured results. The effect of the proportion of the pigments on flexural tensile strength in particular is readily apparent from this figure.

FIG. 8 shows the effect of filler content for different fillers on the average fracture modulus (or, synonymously, modulus of rupture, MOR) of the coated glass panes. It is apparent that even an only small addition of only 1.2% by volume result in an improvement, i.e., an increase, in the fracture modulus, compared to coatings comprising no filler, i.e., only glass flux/binder and pigment. It has surprisingly been found that an addition of silica in particular may be particularly advantageous, in particular at relatively high contents of 13% by volume. This is especially surprising compared to a filler such as O-eucryptite which has a particularly low (in fact negative) coefficient of thermal expansion. It would therefore be expected that such a negative-expansion filler such as O-eucryptite should particularly simply contribute to minimizing/adapting to the glass substrate the resulting coefficient of thermal expansion of the coating, in which the pigments which are relatively high-expansion compared to the glass substrate should optimally even be compensated. However, it appears that the positive effect of such special low-expansion fillers or even negative-expansion fillers is surprisingly less than was thought. This also applies accordingly to porous glass spheres such as “CoralPor®” which were also previously regarded as potentially very advantageous for the resulting thermal expansion and, due to their inherent porosity, also for compensating thermally induced stresses.

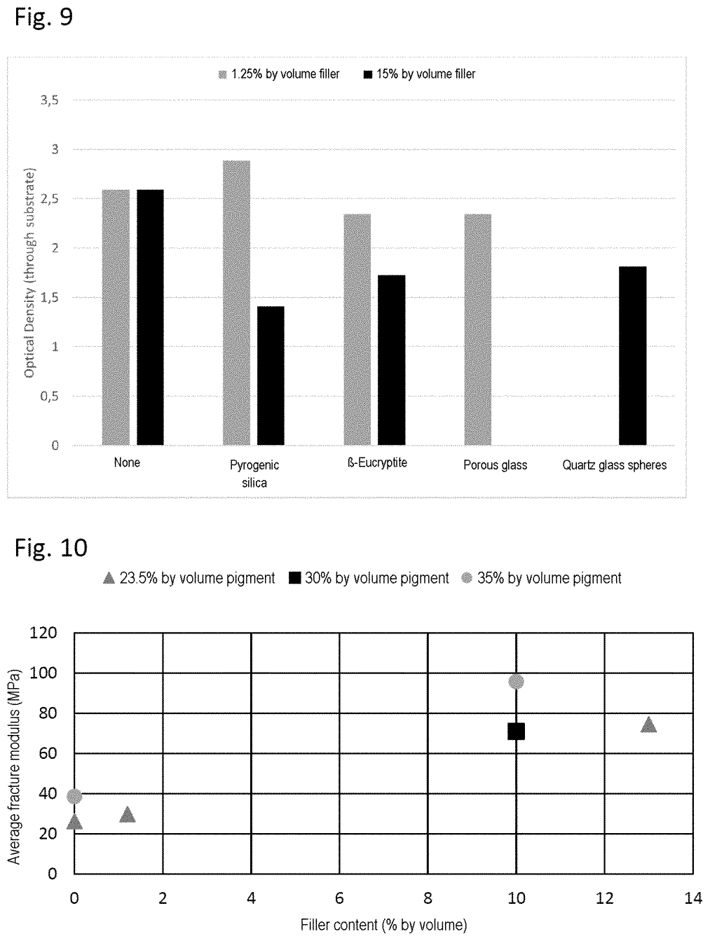

FIG. 9 shows the effect of fillers and filler contents on optical density as determined through the pane. It is apparent that filler addition can even improve optical density, in particular when only a small filler amount is added. This could potentially be due to better distribution of the pigment particles in the coating which could be brought about by small amounts of fillers. However, it goes without saying that this is dependent on the type of filler added. However, for most of the fillers investigated and in particular for higher filler contents the addition of filler is associated with a reduction in optical density, though this is still considered sufficient.

FIG. 10 is a schematic diagram of the effect of pigment and filler content on the resulting average fracture modulus. Higher contents of pigments and higher contents of fillers (wherein the filler used here is a silica) generally also result in higher fracture moduli.

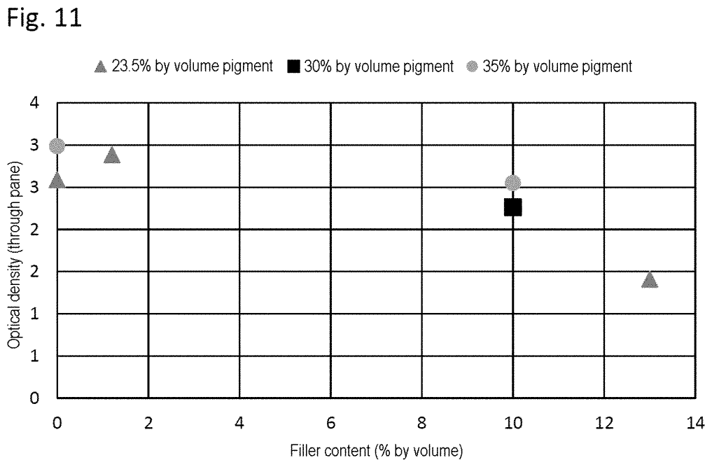

FIG. 11 shows the effect of the filler content and the pigment content of the coating on optical density for the specimens investigated in respect of the resulting fracture modulus in FIG. 10. It is apparent here that up to filler contents of about 10% by volume the effect on optical density is still acceptably small and the above-described negative effect on optical density occurs only at higher filler contents. At low filler contents optical density even initially increases, as already discussed above, at least for the filler considered here, a silica.

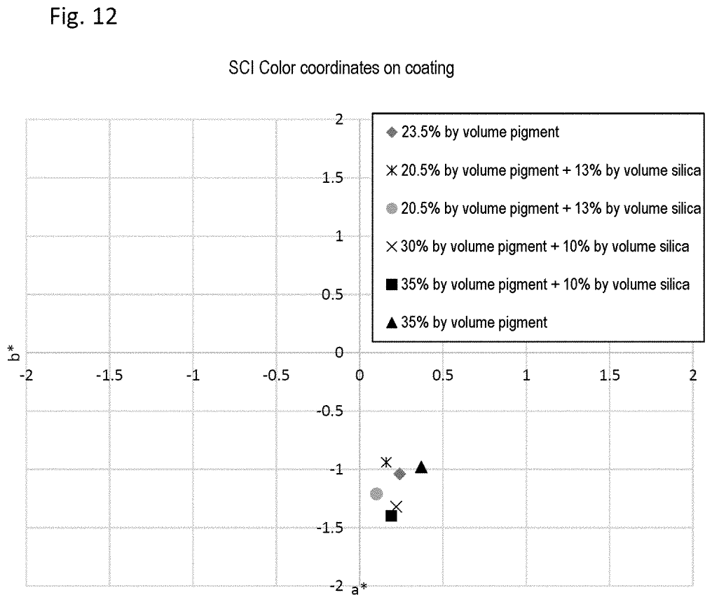

FIG. 12 should the effects of different pigment and filler contents on the resulting color coordinates of the coating. The effect on the resulting coloring of the coating is very small, so that even in the presently considered “achromatic zone” of color coordinates a* and b* only very small and non-systematic divergences occur. This also applies for quite high filler content of 13% by volume.

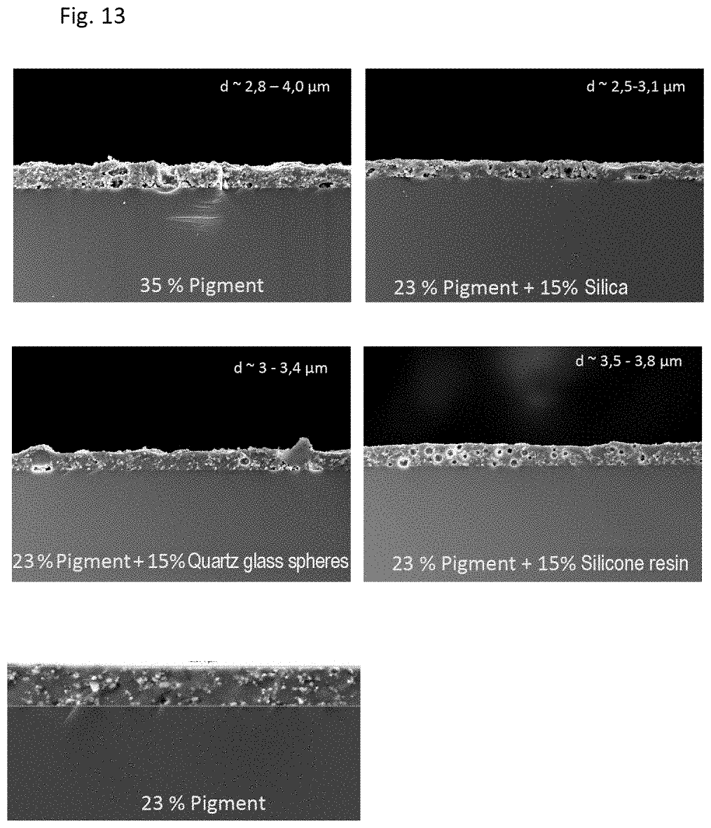

FIG. 13 shows the layer formation for different coatings. The top-left and bottom-left of the figure show two coatings comprising only pigment, at different contents, in addition to the glass flux. The coating shown at the bottom left, which comprises 23% by volume of pigment, shows a smooth, dense coating, while at higher pigment contents a slightly porous layer, which is in particular non-uniform, of up to 4 μm in thickness is formed. Coatings in the middle region of FIG. 13 comprise 23% by volume of pigment and in each case 15% by volume of a filler. While the quartz glass filler (d₅₀ between 1 and 5 μm) results in very unsettled layer buildup where a low scratch resistance results, if only because individual constituents of the coating protrude, the silicone-based fillers of the “Silres®” coating result in a smooth layer with uniformly distributed pores which are formed by the baking of the organic constituents of the filler. However, the coating has become obviously unstable due to the uniformly distributed pores and is therefore disadvantageous in terms of mechanical layer stability.

By contrast, a coating as shown at the top-right of FIG. 13 is associated with particularly great advantages. Even at non-binder contents of more than 37% percent by volume (i.e., comparable to the coating at the top-left of FIG. 10 with 35% by volume of pigment) the employed filler, a silica, nevertheless and very surprisingly results in smooth layer formation comparable to a layer having a markedly lower particulate content (such as the coating with 23% by volume of pigment at the bottom-left). However, the filler addition is here associated with a graduated porosity which in particular increases towards the coating-glass pane interface. It is thought by the inventors that it is precisely this gradient of porosity that results in particularly advantageous formation, so that the coating remains sufficiently scratch resistant while nevertheless achieving a high mechanical strength of the coated glass pane.

### LIST OF REFERENCE NUMERALS

| | |
|---|---|
| 1 | Glass pane |
| 10 | laminate, laminated pane |
| 11 | Coating |
| 101, 102 | Sides of the glass pane |
| 111 | Dot matrix |
| 2 | Further glass pane |
| 3 | Polymeric ply |

What is claimed is:

1. A coated glass pane, comprising:
a glass pane having a first side, the glass pane comprising SiO₂ and B₂O₃; and
a coating comprising a first coating applied in at least one region of the first side, wherein the first coating comprises a binder comprising SiO₂ and a pigment,
wherein the glass pane, in the at least one region, has a flexural strength between at least 5 and at most 170 MPa.

2. The coated glass pane of claim 1, wherein the flexural strength is between at least 20 and at most 170 MPa.

3. The coated glass pane of claim 1, wherein the flexural strength is at least 80 MPa.

4. The coated glass pane of claim 1, wherein the binder is glass-based.

5. The coated glass pane of claim 4, wherein the coating is an enamel layer that further comprises a filler.

6. The coated glass pane of claim 5, wherein the filler has a linear coefficient of thermal expansion between −10*10⁻⁶/K and +10*10⁻⁶/K.

7. The coated glass pane of claim 6, wherein the filler has the linear coefficient of thermal expansion between −6.5*10⁻⁶/K and +3*10⁻⁶/K.

8. The coated glass pane of claim 1, further comprising at least one feature selected from a group consisting of: second coating arranged between the glass pane and the first coating in at least one subregion or within an entirety of the at least one region; the first coating comprises between 0.5% by volume and 50% by volume of pigment; the first coating comprises between 0.5% by volume and 40% by volume of pigment; the first coating comprises between 20% by volume and 40% by volume of pigment; the first coating comprises between 99.5% by volume and 50% by volume of glass frit; the glass pane comprises glass having a linear coefficient of thermal expansion between 2*10⁻⁶/K and 6*10⁻⁶/K; the glass pane comprises at least 60% by weight of SiO₂ to at most 85% by weight of SiO₂; the glass pane comprises at least 7% by weight of B₂O₃ to at most 26% by weight of B₂O₃; the glass pane comprises at least 60% by weight of SiO₂ to at most 85% by weight of SiO₂ and at least 7% by weight of B₂O₃ to at most 26% by weight of B₂O₃; the first coating has a linear coefficient of thermal expansion between at least 3*10⁻⁶/K and at most 10*10⁻⁶/K; the first coating has a linear coefficient of thermal expansion between at least 3*10⁻⁶/K and less than 9*10⁻⁶/K; the glass pane has a thickness between at least 1 mm and at most 12 mm; and any combinations thereof.

9. The coated glass pane of claim 1, wherein the first coating further comprises a blowing agent or a filler.

10. The coated glass pane of claim 1, wherein the binder comprises a glass frit or consists thereof.

11. The coated glass pane of claim 10, wherein the glass frit comprises a coloring constituent.

12. The coated glass pane of claim 10, wherein the pigment in the coating comprises at most 40% by volume.

13. A laminate comprising:
the glass pane of claim 1; and
a further glass pane, wherein the coating is arranged between the glass pane and the further glass pane.

14. A paste for producing a coating on a glass pane, comprising:
at least one binder comprising SiO₂;
at least one pigment; and
a medium, wherein the binder comprises a glass frit or consists thereof and wherein the glass frit comprises a glass comprising, in % by weight based on oxide:
SiO₂ 10 to 70;
B₂O₃ 10 to 26; and
Al₂O₃ more than 0 to 9.

15. The paste of claim 14, wherein the at least one binder, the at least one pigment, and the medium have a viscosity, determined by plate viscometer, between 1500 and 8000 mPas.

16. The paste of claim 15, wherein the at viscosity is between 2000 mPas and 6500 mPas.

17. The paste of claim 15, wherein the at viscosity is between 2500 mPas and 5000 mPas.

18. The paste of claim 14, further comprising at least one feature selected from a group consisting of: between 0.5% by volume and 50% by volume of the at least one pigment; between 0.5% by volume and 40% by volume of the at least one pigment; between 99.5% by volume and 50% by volume of the at least one glass frit; the at least one glass frit having a linear coefficient of thermal expansion between at least 2*10⁻⁶/K and at most 10*10⁻⁶/K; the at least one glass frit having a linear coefficient of thermal expansion between at least 3*10⁻⁶/K and at most 8.5*10⁻⁶/K; a blowing agent; a filler; a filler having a linear coefficient of thermal expansion between −10*10⁻⁶/K and +10*10⁻⁶/K; the glass frit having a coloring constituent; a proportion of the at least one pigment of at most 40% by volume; a proportion of the at least one pigment of at most 20% by volume; and any combinations thereof.
